(19) United States
(12) Patent Application Publication
(10) Pub. No.: US 2026/0082226 A1
(43) Pub. Date: Mar. 19, 2026

(54) SEAL DATA DELIVERY MANAGEMENT

(71) Applicant: Telefonaktiebolaget LM Ericsson (publ), Stockholm (SE)

(72) Inventors: Robert Farac, Herzogenrath (DE); Tuana Ensezgin, Aachen (DE); Efe Demirok, Aachen (DE); Fiona Williams, Aachen (DE); Felix Maier, Aachen (DE); Alexandra Bach, Aachen (DE); Wenliang Xu, Shanghai, Shanghai (CN); Ala Nazari, Handen (SE)

(21) Appl. No.: 19/110,684

(22) PCT Filed: Oct. 3, 2023
(86) PCT No.: PCT/IB2023/059932

§ 371 Date: Mar. 11, 2025

(30) Foreign Application Priority Data
Oct. 3, 2022 (WO) PCT/CN2022/123680

(51) Int. Cl. H04W 12/08; H04W 80/08

(52) U.S. Cl. CPC H04W 12/08; H04W 80/08

(57) ABSTRACT

Systems and methods are disclosed that relate management of Service Enabler Architecture Layer for verticals (SEAL) data delivery via a cellular communications system. In one embodiment, a method performed by a system for SEAL data delivery via a telecommunication system comprises, at a Vertical Application Layer (VAL) server of a regulator domain, determining a policy for data delivery from a client in a first business actor domain to a VAL server in a second business actor domain wherein the data delivery is via SEAL data delivery communication over telecommunication system. The method further comprises, at the VAL server of the regular domain, providing the policy to a SEAL data delivery server in the regulator domain for enforcement of the policy comprising establishing a data delivery connection between the first business actor domain (SEAL DD client) and the second actor business domain (VAL server).

### RELATED APPLICATIONS

This application claims the benefit of international patent application serial number PCT/CN2022/123680, filed Oct. 3, 2022, the disclosure of which is hereby incorporated herein by reference in its entirety.

### TECHNICAL FIELD

The present disclosure relates to data delivery management on a Service Enabler Architecture Layer for Verticals (SEAL) standards.

### BACKGROUND

Exposure of the 5^{th} Generation (5G) capabilities and resources of a 5G System (5GS) is highly requested by vertical applications. Ericsson is ahead of all telecom vendors in the area of device connectivity management capabilities exposure. Device connectivity management exposure is being intensively investigated in the industrial context (see, e.g., 5G-ACIA, “Exposure of 5G Capabilities for Connected Industries and Automation Applications,” 2021). Ericsson has been contributing the work in device connectivity management capabilities exposure to the 3^{rd} Generation Partnership Project (3GPP) Service Enabler Architecture Layer for Verticals (SEAL) standards (see 3GPP, “TS 23.434; Technical Specification Group Services and System Aspects; Service Enabler Architecture Layer for Verticals (SEAL); Functional architecture and information flows; Release 18,” 2022 and 3GPP, “TS 29.549; Technical Specification Group Core Network and Terminals; Service Enabler Architecture Layer for Verticals (SEAL); Application Programming Interface (API) specification; Stage 3 (Release 17),” 2022).

### SUMMARY

Systems and methods are disclosed that relate to management of Service Enabler Architecture Layer for verticals (SEAL) data delivery via a cellular communications system. In one embodiment, a method performed by a system for SEAL data delivery via a cellular communications system comprises, at a Vertical Application Layer (VAL) server of a regulator domain of the system, determining a policy, the policy being for data delivery from a client (e.g., SEAL DD client) in a first business actor domain of the system to a VAL server in a second business actor domain of the system wherein the data delivery is via SEAL data delivery communication. The method further comprises, at the VAL server of the regular domain, providing the policy to a SEAL data delivery server in the regulator domain of the system for enforcement of the policy. The method further comprises, at the SEAL data delivery server, receiving the policy from the VAL server of the regulator domain of the system for enforcement of the policy for data delivery from the VAL client in the first business actor domain of the system to the VAL server in the second business actor domain of the system wherein the data delivery is via SEAL data delivery communication over a cellular communications system. The method further comprises, at the SEAL data delivery server, enforcing the policy for data delivery between the first business actor domain and the second business actor domain, such as triggering a data delivery (DD) communication channel between the first and second business actor doe delivery of data. In this way, the data owner (e.g., first business actor) is enabled to share the data to the data user (e.g., second business actor) in a secure way.

Embodiments of a VAL server in a regulator domain and methods of operation thereof are also disclosed.

Embodiments of a SEAL data delivery server in the regulator domain and methods of operation thereof are also disclosed.

In one embodiment, a method performed by a system for SEAL data delivery via a cellular communications system comprises, at a VAL server of a regulator domain of the system, transmitting, to a SEAL data delivery server in the regulator domain of the system, a request comprising a policy for connection establishment for data delivery from a VAL client in a first business actor domain of the system to a VAL server in a second business actor domain of the system. The method further comprises, at the SEAL data delivery server of the regulator domain of the system, receiving, from the VAL server of the regulator domain of the system, the request comprising the policy for connection establishment for data delivery from the VAL client in the first business actor domain of the system to the VAL server in the second business actor domain, authorizing the request, and storing the policy for enforcement.

In one embodiment, the policy is preconfigured in the regulator domain.

In one embodiment, the method further comprises, at the SEAL data delivery server in the regulator domain of the system, determining that the policy for connection establishment for data delivery is to be enforced and, in accordance with the policy, sending, via a cellular communications system, a data delivery connection establishment notification to a SEAL data delivery client in the first business actor domain of the system that communicates with the VAL client in the first business actor domain of the system, for establishing a first connection for data delivery, sending a data delivery connection establishment notification to the VAL server in the second business actor domain, for establishing a second connection for data delivery, and enabling data delivery between the VAL client via the SEAL data delivery client and the VAL server over the first and the second connections.

In one embodiment, the method further comprises, at the VAL server in the regulator domain, determining that the policy for data delivery is to be updated and transmitting, to the SEAL data delivery server in the regulator domain of the system, an update request comprising an updated policy for connection establishment for data delivery from the VAL client in the first business actor domain of the system to the VAL server in the second business actor domain of the system. The method further comprises, at the SEAL data delivery server in the regulator domain, receiving the update request comprising the updated policy, authorizing the update request, and storing the updated policy to be enforced.

In one embodiment, the method further comprises, at the SEAL data delivery server of the regulator domain, determining to delete the second connection with the VAL server in the second business actor domain and the first connection with the SEAL data delivery client in the first business actor domain, notifying the VAL server in the second business actor domain that the second connection is to be deleted, and notifying the SEAL data delivery client that the first connection is to be deleted.

In one embodiment, a method performed by a SEAL data delivery server of a regulator domain of a system for providing SEAL data delivery via a cellular communications system comprises receiving, from a VAL server of the regulator domain of the system, a request comprising a policy for connection establishment for data delivery from a VAL client in a first business actor domain of the system to the VAL server in a second business actor domain of the system. The method further comprises authorizing the request and storing the policy for enforcement.

In one embodiment, the policy is preconfigured in the regulator domain.

In one embodiment, the method further comprises determining that the policy for connection establishment for data delivery is to be enforced and, in accordance with the policy, sending, via a cellular communications system, a data delivery connection establishment notification to a SEAL data delivery client in the first business actor domain of the system that communicates with the VAL client in the first business actor domain of the system, for establishing a first connection for data delivery, sending a data delivery connection establishment notification to the VAL server in the second business actor domain, for establishing a second connection for data delivery, and enabling data delivery between the VAL client via the SEAL data delivery client and the VAL server over the first and the second connections.

In one embodiment, the method further comprises receiving, from the VAL server in the regulator domain of the system, an update request comprising an updated policy for connection establishment for data delivery from the VAL client in the first business actor domain of the system to the VAL server in the second business actor domain of the system, authorizing the update request, and storing the updated policy to be enforced.

In one embodiment, the method further comprises determining to delete the second connection with the VAL server in the second business actor domain and the first connection with the SEAL data delivery client in the first business actor domain, notifying the VAL server in the second business actor domain that the second connection is to be deleted, and notifying the SEAL data delivery client that the first connection is to be deleted.

Corresponding embodiments of a SEAL data delivery server are also disclosed. In one embodiment, a SEAL data delivery server for a regulator domain of a system for providing SEAL data delivery via a cellular communications system is adapted to receive, from a VAL server of the regulator domain of the system, a request comprising a policy for connection establishment for data delivery from a VAL client in a first business actor domain of the system to the VAL server in a second business actor domain of the system. The SEAL data delivery server is further adapted to authorize the request and store the policy for enforcement.

Corresponding embodiments of a server computer for implementing a SEAL data delivery server are also disclosed. In one embodiment, a server computer for implementing a SEAL data delivery server for a regulator domain of a system for providing SEAL data delivery via a cellular communications system comprises a network interface and processing circuitry associated with the network interface. The processing circuitry is configured to cause the server computer to, in order to operate as the SEAL data delivery server, receive, from a VAL server of the regulator domain of the system, a request comprising a policy for connection establishment for data delivery from a VAL client in a first business actor domain of the system to the VAL server in a second business actor domain of the system, authorize the request, and store the policy for enforcement.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of data delivery between business actors in accordance with one embodiment of the present disclosure;

FIG. 2 illustrates an on-network functional model for data distribution management on SEAL layer in accordance with one embodiment of the present disclosure;

FIG. 3 illustrates a Data Delivery (DD) policy creation procedure in accordance with some embodiment of the present disclosure;

FIG. 4 illustrates a DD policy enforcement and DD com. Establishment in accordance with an embodiment of the present disclosure;

FIG. 5 illustrates a DD policy enforcement and DD com. Establishment in accordance with yet another embodiment of the present disclosure;

FIG. 6 illustrates a DD policy information query procedure in accordance with one embodiment of the present disclosure;

FIG. 7 illustrates a DD policy information query procedure in accordance with another embodiment of the present disclosure;

FIG. 8 illustrates a DD communication information query procedure in accordance with one embodiment of the present disclosure;

FIG. 9 illustrates a DD communication information query procedure in accordance with another embodiment of the present disclosure;

FIG. 10 illustrates a DD policy update procedure in accordance with one embodiment of the present disclosure;

FIG. 11 illustrates a DD communication update procedure in accordance with another embodiment of the present disclosure;

FIG. 12 illustrates a DD policy deletion procedure in accordance with one embodiment of the present disclosure;

FIG. 13 illustrates a DD communication deletion notification procedure in accordance with an embodiment of the present disclosure;

FIG. 14 illustrates a DD communication deletion procedure in accordance with one embodiment of the present disclosure;

FIG. 15 illustrates a DD policy deletion procedure in accordance with another embodiment of the present disclosure;

FIGS. 16 and 17 are schematic block diagrams of a server computer according to some embodiments of the present disclosure; and

FIG. 18 is a schematic block diagram of a User Equipment device (UE) according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

5G API: A 5^{th} Generation (5G) Application Programming Interface (API) is an application programming interface that exposes the capabilities of a 5G network to the users, specifically to business actors and regulators in the preferred use case described herein. The 5G API acts as a broker between the 5G network and the users. It allows users to directly manage and monitor the connectivity or quality of the network without involving a person working at the mobile network operator. Therefore, it provides simplicity to the users, as they can simply send requests on their own to make changes in the 5G network, add their devices to the network or create new device groups, etc. Then, the 5G API can forward these requests to the relevant 5G core network functions to perform the necessary operation requested by the users.
Application: An application is an application from a business actor. It can be located on any computing engine (e.g., cloud or edge cloud).
Business Actor: A business actor is an actor who is authorized to use the 5G API to e.g., request a communication policy creation, establish communication links, etc. This actor can be from any vertical sector including robotics companies, software development companies, railway companies, and power distribution companies.
Data Orchestrator: A data orchestrator is a software entity that has the mechanism to collect data from many data sources, sort them, and retransmit the data for a specific period of time. It is responsible for orchestrating when to enable the communication between business actors and how long to allow the data transmission.
Regulator: A regulator is a business entity that is authorized to enable communications between different business actors. It can either do this operation manually, or it can program the data orchestrator to enable/disable communication itself.
Vertical Device: A vertical device is a physical asset from a business actor which is connected to a 5G User Equipment (UE). This device can collect or generate data in a field to be transmitted to an application over the 5G network.

Certain challenges exist with existing technology. In particular, live data streams from field devices and data processed by applications or stored in databases are used for analysis and other purposes by the data owner. The data could be provided to other business actors from the same or different vertical sector. Other business actors would analyze the data and provide added value services to the data owner. Sharing the data with other business actors would be beneficial to both the service provider and the data owner. However, sharing the data between business actors is not currently possible or is possible only in a very limited manner.

Nowadays, the data owner cannot share the data with other business actors in a convenient way while keeping its critical infrastructure safe. Furthermore, an access cannot be provided in predefined time windows. In practice, it is often the case that the data needs to be provided only in specific time intervals, e.g., when no critical infrastructure operations are conducted.

One of the existing solutions to these problems is data exchange through Virtual Private Networks (VPNs). However, setting and configuring the VPN solution requires Information Technology (IT) expertise that both the data owner and other business actors often do not have. For example, a VPN needs to be configured, login details and keys need to be shared among the data owner and other business actors, and firewalls need to be properly setup. Furthermore, cabled communications utilized nowadays are less flexible and less cost-efficient alternative compared to the wireless communications, etc. Accordingly, sharing of the data with other business actors is a complex task.

Systems and methods are disclosed herein that address the aforementioned and/or other challenges. Embodiments of the proposed solution enable a data owner to permit sharing of their data in a convenient way with other business actors, i.e., data users. A data user can either be an actor from the same vertical sector as the data owner, or the data user can be an actor from a different vertical sector. In addition, there will be a third actor referred to herein as the regulator. The regulator manages secure data sharing between the data owner and the data user.

In one embodiment, the data owner has the right to define when and how frequently its data will be shared with the data user. The data owner allows the regulator to be responsible for managing the data sharing between itself and the data user, whenever it suits the data owner. The regulator is able to define time windows, according to the data owner's preference, in which the data owner will provide the data to the data user. The data owner and the data user are communicating between each other in a secured way using the standard communication security procedures typical for mobile networks.

In one embodiment, the solution is implemented in a wireless network such as, e.g., a 3GPP network such as, e.g., a 5G network. The data owner, the data user, and the regulator interact with the wireless network through an extended wireless network API (e.g., an extended 5G API).

In one embodiment, data distribution between different business actors is defined by a regulator and business actor(s). Data distribution is defined in terms of setting of communication endpoints, time when the communication will be allowed, and setting other communication characteristics such as, e.g., quality of the communication link. In existing mobile networks, these capabilities are handled by mobile network operators; however, in embodiments of the present disclosure, these capabilities are provided to the user through a new API (e.g., a new or extended 5G API). The users (e.g., the regulator and business actors) are able to set communications between devices and applications belonging to business actors in a way described herein.

While not being limited by or to any particular advantages, embodiments described herein may provide a number of advantages over existing technology. Embodiments of the present disclosure enable the data owner to share data in a secured way to the data user, i.e., another business actor from the same or different vertical sector. Through data analysis, the data user will be able to provide new services that will improve operations of the data owner's organization. The data owner and the data user do not need to have IT expertise knowledge to achieve this task. The new API (e.g., new or extended 5G API) will enable simple communication management to the regulator and business actors.

Embodiments of the proposed solution enable exchange of selected data between business actors in a flexible and a secured way provided and managed by a trusted regulator. The data owner will share its data with the data user, through the trusted regulator, whenever it suits itself without endangering critical infrastructure resources. Furthermore, data sharing may be further optimized by automating operations with an orchestration tool.

Various aspects of embodiments of the present disclosure will now be described in the following sub-sections. Note, however, that the various aspects may be utilized separately or together in any suitable combination.

### 1 Data Delivery Management Requirements

This sub-section specifies general requirements for a data delivery management service in accordance with embodiments of the present disclosure. The requirements are related to users of the service, e.g., business actors and regulator.

### 1.1 Business Actor Requirements

In accordance with embodiments of the present disclosure, the data delivery management service described herein fulfills any one or more or preferably all of the following service requirements related to the business actor:
[SR-6.1.1-a] The business actor is able to delete the established communication in which its data or applications are involved in emergency situations. The relevant policy will be deleted by the regulator after successful deletion of the communication.
[SR-6.1.1-b] The business actor is able to query the policy details of all policies defined for its devices or applications.
[SR-6.1.1-c] The business actor is able to query the communication performance (e.g., current latency, packet loss, throughput etc.) of all established connections for its devices or applications.

### 1.2 The Regulator Requirements

In accordance with embodiments of the present disclosure, the data delivery management service described herein fulfills any one or more or preferably all of the following service requirements related to the regulator:
[SR-6.1.2-a] The regulator will be able to create, update and delete data delivery policies. The communication will be established or deleted as defined in the policy. In some cases, live communication will be updated without deleting and reestablishing a communication link.
[SR-6.1.2-b] The regulator is able to delete any of the established communications in emergency situations. The relevant policy will be deleted after successful deletion of the communication.
[SR-6.1.2-c] The regulator requests for data transmission from a business actor and forwards the data to another business actor.
[SR-6.1.2-d] Only the regulator is allowed to establish communication between business actors.
[SR-6.1.2-e] The regulator is able to query the policy details of all policies.
[SR-6.1.2-f] The regulator is able to query the communication performance (e.g., current latency, packet loss, throughput etc.) of all established connections.

### 2 Business Relationships for Data Delivery Management

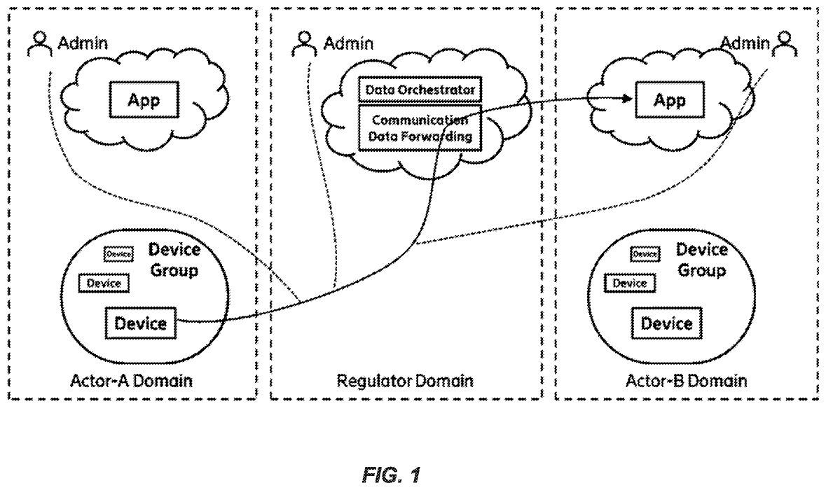

FIG. 1 illustrates an example of data delivery scenario where data is transmitted from one business actor to another. In the illustrated scenario, a device of actor A (referred to herein as “the actor A device”) provides data to an application of actor B (referred to herein as “the actor B application”). Communication is established by a regulator based on a predefined policy (e.g., a policy defined by previous agreement between the business actors). The regulator forwards the data from the business actor A to the business actor B (e.g., from the actor A device to the actor B application). Note that the business actor B application can send data to the business actor A device but this case is not reflected in FIG. 1.

### 3 Functional Model for the Data Delivery Management

The functional model for the data delivery management service is organized into functional entities to describe a functional architecture which addresses the support for data delivery management aspects for vertical applications. Note that these functional entities may be implemented in a suitable physical architecture. For example, each of the functional entities may be implemented on a corresponding device or network node (e.g., via execution of corresponding software executed by a processor(s) of the respective device or network node).

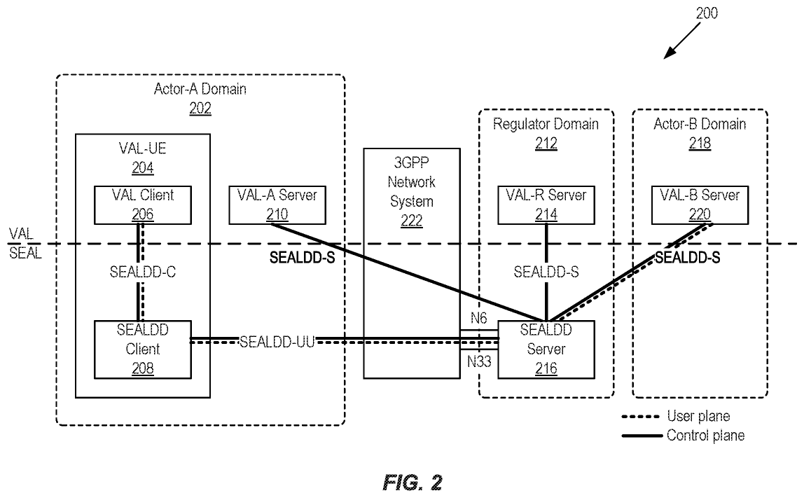

FIG. 2 depicts the network functional model for the data delivery management service with corresponding functional entities and the reference points. The diagram is following the principal approach used in 3GPP SEAL standards (see 3GPP TS 23.434). Service Enabler Architecture Layer (SEAL) enables the use of 5G capabilities to applications from the same or different vertical sectors. SEAL architecture considers 5G capabilities to support mission critical applications as well.

FIG. 2 illustrates an example of the use case where data is delivered from the business actor A device to an application belonging to the business actor B. However, it is possible that the data is delivered by the business actor B application to the business actor A device, but this scenario is not reflected in FIG. 2.

A SEAL Data Delivery (SEALDD) server creates connections to the device and the application by interacting with 3GPP system (Network Exposure Function-NEF) via N33 interface. Furthermore, the SEALDD server can send notifications to the device and the applications, but this is optional. The regulator can request Data Delivery (DD) policy creation and deletion. After the policy is created, the application communication via SEALDD is established. During the application communication, the DD policy is enforced by the SEALDD server (regulator).

More specifically, as illustrated in FIG. 2, a system 200 represented by the architecture includes the following components:
In a domain 202 of business actor A (i.e., the “Actor-A domain 202”):
   a device shown as User Equipment (UE) denoted herein as a VAL-UE 204, which includes:
      a VAL client 206, and
      a SEALDD client 208, and
   a VAL server denoted herein as a VAL-A server 210.
In a domain 212 of the regulator (i.e., the “regulator domain 212”):
   a VAL server 214 of the regulator, which is referred to as the “VAL-R server 214”, and
   a SEALDD server 216.
In a domain 218 of business actor B (i.e., the “Actor-B domain 218”):
   a VAL server 220 denoted herein as a “VAL-B server 220”.
A 3GPP network system 222 (aka telecommunication system in general) (e.g., a 5G network which may also be referred to herein as a 5G system).

### 3.1 Functional Entities Description

### 3.1.1 SEALDD Client

The SEALDD client (i.e., the SEALDD client 208) is the functional entity that provides the client-side functionalities corresponding to the data delivery management service and belonging to the business actor. The SEALDD client is deployed on the business actor's device and server. The SEALDD client interacts with the SEALDD server (i.e., the SEALDD server 216). The SEALDD client also supports interactions with the corresponding SEALDD client between the two UEs. In one example embodiment, the SEALDD client is implemented as software that is stored and executed (e.g., by a processor(s)) of a respective device (e.g., the VAL-UE 204) that is owned or otherwise associated to a respective business actor (e.g., business actor A in the example of FIG. 2).

### 3.1.2 SEALDD Server

The SEALDD server (i.e., the SEALDD server 216) is the functional entity that provides the server-side functionalities corresponding to the data delivery management service and belonging to the regulator. The entity is deployed on the regulator's server. The function of the SEALDD server is to enforce policies defined by VAL servers. In one example embodiment, the SEALDD server is implemented as software that is stored and executed (e.g., by a processor(s)) of a respective server computer(s) owned or otherwise associated to the regulator.

### 3.1.3 VAL Client

The VAL client (i.e., VAL client 206) is the functional entity that provides the client-side functionalities corresponding to the business actor or regulator application. VAL client participates in definition of policies together with VAL clients and servers of the regulator and business actors. In one example embodiment, the VAL client is implemented as software that is stored and executed (e.g., by a processor(s)) of a respective device (e.g., the VAL-UE) that is owned or otherwise associated to a respective business actor (e.g., business actor A in the example of FIG. 2).

### 3.1.4 VAL-A Server

The VAL-A server (i.e., VAL-A server 210) is the functional entity that provides the server-side functionalities corresponding to the business actor application, in this example to the actor A. VAL-A server participates in definition of policies together with VAL clients and servers of the regulator and business actors. In one example embodiment, the VAL-A server is implemented as software that is stored and executed (e.g., by a processor(s)) of a respective server computer(s) that is(are) owned or otherwise associated to the respective business actor (e.g., business actor A in the example of FIG. 2).

### 3.1.4 VAL-B Server

The VAL-B server (i.e., the VAL-B server 220) is the functional entity that provides the server-side functionalities corresponding to the business actor application, in this example to the actor B. VAL-B server participates in definition of policies together with VAL clients and servers of the regulator and business actors. In one example embodiment, the VAL-B server is implemented as software that is stored and executed (e.g., by a processor(s)) of a respective server computer(s) that is(are) owned or otherwise associated to the respective business actor (e.g., business actor B in the example of FIG. 2).

### 3.1.5 VAL-R Server

The VAL-R server (i.e., the VAL-R server 214) is the functional entity that provides the server-side functionalities corresponding to the regulator application. VAL-R server participates in definition of policies together with VAL clients and servers of business actors. In one example embodiment, the VAL-R server is implemented as software that is stored and executed (e.g., by a processor(s)) of a respective server computer(s) that is(are) owned or otherwise associated to the regulator.

### 3.2 Reference Points Description

The reference points for the functional model for the data delivery management are described in the following subchapters.

### 3.2.1 N33

The reference point N33 supports the interactions between the SEALDD server 216 and the Network Exposure Function (NEF) in the 3GPP network system 222 and is specified in 3GPP, “TS 23.501, Technical Specification Group Services and System Aspects, System Architecture for the 5G System (5GS), Stage 2. Release 17,” 2022. The SEALDD server 216 interacts with the NEF via N33 to obtain Quality of Service (QOS) information from the 3GPP network system 222 and to request establishment of the DD communication. N33 is used for the network-based mechanism for network slice re-mapping.

### 3.2.2 N6

The N6 interface provides connectivity between the User Plane Function (UPF) in the 3GPP network system 222 and the data network (e.g., internet).

### 3.2.3 SEALDD-C

The interactions related to data delivery management functions between the VAL client 206 and the SEALDD client 208 within a business actor UE (i.e., the VAL-UE 204 in the example of FIG. 2) are supported by SEALDD-C reference point.

### 3.2.4 SEALDD-S

The interactions related to data delivery management functions between business actor and regulator VAL server(s) (i.e., the VAL-R server 214 in the example of FIG. 2) and the data delivery management (SEALDD) server (i.e., the SEALDD server in the example of FIG. 2) are supported by SEALDD-S reference point. Note that SEALDD is on one side and the VAL server(s) are on the other side.

### 3.2.5 SEALDD-UU

The interactions related to data delivery management functions between the data delivery management (SEALDD) client (i.e., the SEALDD client 208 in the example of FIG. 2) and the data delivery management (SEALDD) server (i.e., the SEALDD server 216 in the example of FIG. 2) are supported by SEALDD-UU reference point.

This reference point utilizes Uu reference point as described in 3GPP TS 23.501.

### 4 Procedures and Information Flows for New Service

### 4.1 General

Presumptions for the new service procedures:
In this document, a communication between VAL servers is not shown.
The SEALDD client is authorized and authenticated by the SEALDD server belonging to different business actors, i.e., different VAL system.
User authentication and authorization procedures are described in 3GPP TS 33.434 Clause 5.4.
The business actor B (VAL-B server) can trigger the same procedures as the business actor A, but they are not shown herein.
A device belonging to the business actor A will be able to send data to the application deployed on the server belonging to the business actor B.
The regulator only forwards the data received from one actor to another actor. It does not store the data.
Devices and applications exchanging data do not belong to the regulator.
The VAL-R server has a data delivery (DD) policy available. The policy can be based on offline or online agreement with VAL-A client-side administrator and VAL-B server-side administrator.

The following procedures are described in the following sub-sections:
Data Delivery (DD) policy creation
Data Delivery (DD) communication establishment
Data Delivery (DD) policy information query
   Request from a business actor
   Request from the regulator
Data Delivery (DD) communication information query
   Request from a business actor
   Request from the regulator
Data Delivery (DD) policy update
Data Delivery (DD) communication update
Data Delivery (DD) policy deletion
Data Delivery (DD) communication deletion
   Request from a business actor
   Request from the regulator

Note that the description herein focuses on embodiments related to data delivery from the device to the application. Similar procedures are valid for data delivery from the application to the device.

### 4.2 Data Delivery (dd) Policy Creation

### 4.2.1 General

A business actor and the regulator can request Data Delivery (DD) policy creation.

A business actor requests, from the regulator, the policy creation for a communication to another business actor providing information about actor users/UEs and a communication time schedule. The regulator checks whether it is allowed to fulfil the request, e.g., checking contracts, Service Level Agreements (SLAs), communication schedules, etc., and asks the other business actor for the approval. Finally, the regulator creates the new policy and informs the business actors about the new policy creation.

The regulator creates the policy with information about actor users/UEs that will participate in communication and a communication time schedule and informs the business actors about the new policy creation. The regulator can ask the business actors for the approval to set up the new policy.

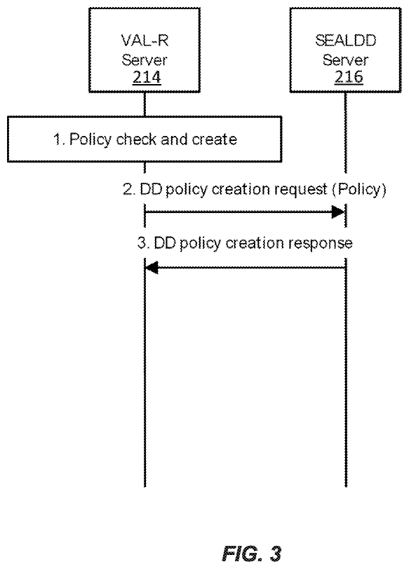

FIG. 3 illustrates an embodiment of DD Policy creation in accordance with one embodiment. The regulator creates the policy, with an info about actor users/UEs that will participate in communication and a communication time schedule and informs actors about the new policy creation.

In FIG. 3, the VAL-R server 214 performs a policy check and determines that a policy is to be created (step 1). In other words, the VAL-R server 214 checks whether the same policy has already been created before creating the policy. The VAL-R server 214 sends a DD policy creation request to the SEALDD server 216 (step 2). The request includes policies (e.g., data delivery start and stop time, data delivery Quality of Service (QOS), sender identity (ID) (VAL user ID or UE ID) and receiver ID (VAL server ID), spatial condition for UE) and VAL service ID.

Upon receiving the request, the SEALDD server 216 authorizes the request and creates a policy. Then the SEALDD server 216 responds to the VAL-R server 214 (step 3).

Note: SEALDD server 216 will store the policy and will use it during enforcement of the communication establishment afterwards.

Note: Policy ID can be created either by SEALDD server 216 or the VAL-R server 214.

After step 2, the VAL-R server 214 may notify the VAL-A client-side administrator and VAL-B server-side administrator, such communication that can happen via VAL-UU reference point.

### 4.3 Data Delivery (DD) Communication Establishment

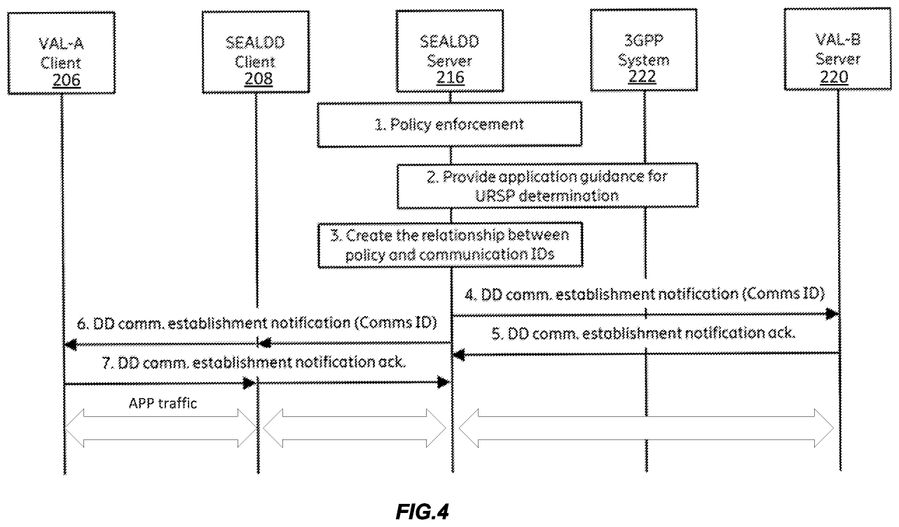

The regulator requests from the 3GPP system an establishment of a DD communication between business actors based on the defined policy and informs business actors about the new DD communication establishment. FIG. 4 illustrates the procedure for establishment of the DD communication.

Pre-conditions:

The SEALDD server 216 has received and stored the policy from the VAL-R server 214 during the policy creation or update procedure. The steps of the procedure of FIG. 4 are as follows:
Step 1: When the time for data transmission is about to start, the SEALDD server 216 enforces the policy to trigger DD connection establishment. If spatial condition for UE is provided, the SEALDD server 216 also ensures the UE's location requirement is satisfied when establishing DD connection (e.g., by using NEF service for monitoring UE location or SEAL location service for UE entering area of interest).
Step 2: If there is a special routing requirement for SEALDD user plane traffic (e.g., running on a specific slice and Data Network Name—DNN), the SEALDD server 216 interacts with 3GPP Core Network (CN) to provision service specific parameters with NEF as described in 3GPP TS 23.502, clause 4.15.6.10 and clause 4.15.6.7.
Step 3: The SEALDD server 216 creates the relationship between the policy and the communication IDs.
Steps 4-5:: The SEALDD server 216 allocates an Internet Protocol (IP) address and port for sending and receiving packet over SEALDD-S reference point, then the SEALDD server 216 sends DD connection establishment notification to the VAL-B server 220 with VAL service ID, the IP address, and port. The notification is acknowledged by the VAL-B server.
Steps 6-7:. The SEALDD server 216 allocates an IP address and port for sending and receiving packets over SEALDD-UU reference point, then the SEALDD server 216 sends DD connection establishment notification to the SEALDD client 208 with VAL service ID, the IP address, and port. The notification is acknowledged by the SEALDD client 208. The SEALDD client 208 further notifies the VAL-A client 206 about the DD connection being established.

Upon receiving application traffic from the VAL-A client 206, the SEALDD client 208 sends it to the SEALDD server 216 in SEALDD traffic. The SEALDD server 216 identifies the application traffic based on the VAL service ID and further sends the application traffic to the VAL-B server 220.

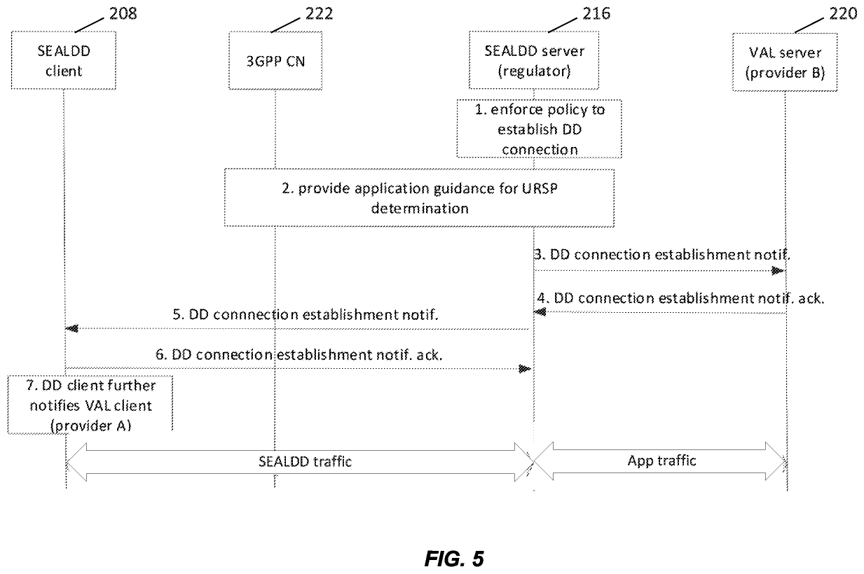

FIG. 5 illustrates the procedure for establishment of the DD connection according to an embodiment.

Pre-conditions:
The SEALDD server 216 (regulator) has DD policies received from the VAL server 214 (regulator).
The VAL server 220 (provider B) and SEALDD client 208 have subscribed to receive notifications from the SEALDD server 216 (regulator).

The steps of the procedure of FIG. 5 are as follows:
Step 1: When the time for data transmission is about to start, the SEALDD server 216 (regulator) enforces the policy to trigger DD connection establishment. If spatial condition for UE is provided, the SEALDD server 216 (regulator) also ensures the UE's location requirement is satisfied when establishing DD connection (e.g., by using NEF service for monitoring UE location or SEAL location service for UE entering area of interest).
Step 2: If there is a special routing requirement for SEALDD user plane traffic (e.g., running on a specific slice and DNN), the SEALDD server (regulator) interacts with 3GPP CN to provision service specific parameters with NEF as described in 3GPP TS 23.502, clause 4.15.6.10 and clause 4.15.6.7.
Steps 3-4: The SEALDD server 216 allocates an IP address and port for sending and receiving packet over SEAL-S reference point, then the SEALDD server 216 sends DD connection establishment notification to the VAL server 220 (provider B) with VAL service ID, the IP address, and port. The notification is acknowledged by the VAL server 220 (provider B).
Steps 5-6:. The SEALDD server 216 allocates an IP address and port for sending and receiving packet over SEAL-Uu reference point, then the SEALDD server 216 sends DD connection establishment notification to the SEALDD client 208 with VAL service ID, the IP address, and port. The notification is acknowledged by the SEALDD client 208. UE IP address (and port) may be included by the SEALDD client 208 in the notification acknowledgement or sent in a separate update message by the SEALDD client 208 if a different UE IP address is to be used in DD connection user plane.
NOTE: Step 3 and step 5 can be done in parallel.
Step 7:. The SEALDD client 208 further notifies the VAL client 206 (provider A) about the DD connection being established.
Upon receiving application traffic from VAL client 206 (not shown in the figure), the SEALDD client 208 sends it to the SEALDD server 216 (regulator) in SEALDD traffic. The SEALDD server 216 (regulator) identifies the application traffic based on the VAL service ID and further sends the application traffic to the VAL server 220 (provider B). The downlink application traffic sent from the VAL server 220 to the VAL client 206 is processed similarly.

### 4.4 Data Delivery (dd) Policy Information Query

### 4.4.1 General

A business actor or the regulator can query for the DD policy information.

A business actor requests from the regulator information about DD policies in which actor user/UE is involved.

The regulator requests information about DD policies in which actor users/UEs are involved.

### 4.4.2 Request From a Business Actor

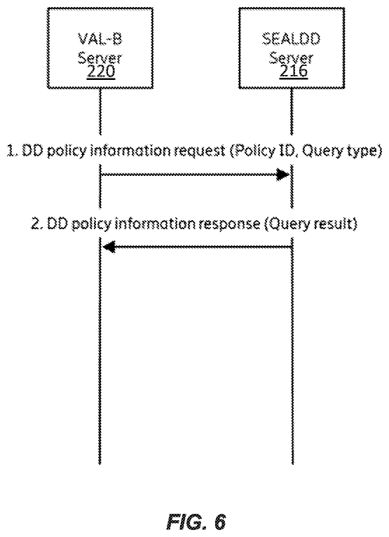

FIG. 6 illustrates the procedure for querying the DD policy information triggered by a business actor.

Pre-conditions:
The business actor wants to check if the policy is applied correctly. Afterwards, the business actor can take consequent actions, e.g., request the policy update or delete or creation of the new policy or enforce the communication deletion.

The steps of the procedure of FIG. 6 are as follows:
Step 1: The VAL-B server 220 sends the policy information request to the SEALDD server 216. The VAL-B server 220 can request the specific policy information through the query type such as data delivery time windows. The policy ID that is specified in the request has been received from the VAL-R server 214 during the policy creation beforehand.
Note: The policy information request can be sent by VAL-A server 210 as well.
Step 2: The SEALDD server 216 provides the requested policy information with a policy information response message.

Note that while the example embodiment of FIG. 6 illustrates the request of step 1 coming from the VAL-B server 220, the request may alternatively be from the VAL-A server 210.

### 4.4.3 Request from the Regulator

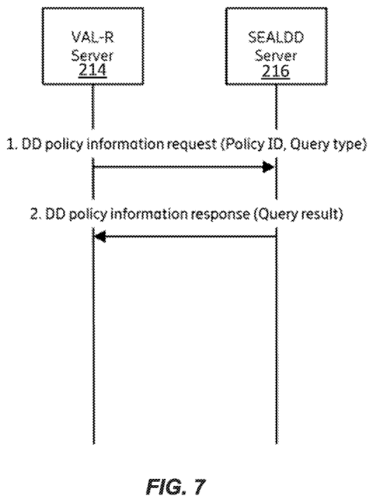

FIG. 7 illustrates the procedure for querying the DD policy information triggered by the regulator.

Pre-conditions:
The regulator wants to check if the policy is applied correctly. Afterwards, the regulator can take consequent actions, e.g., request the policy update or delete or creation of the new policy or enforce the communication deletion.

The steps of the procedure of FIG. 7 are as follows:
Step 1:: The VAL-R server 214 sends the policy information request to the SEALDD server 216. The VAL-R server 214 can request the specific policy information through the query type such as data delivery time windows.
Step 2:: The SEALDD server 216 provides requested policy information with the policy information response message.

### 4.5 Data Delivery (dd) Communication Information Query

### 4.5.1 General

A business actor and the regulator can query for the DD communication information.

A business actor requests from the regulator an information about established communication in which actor user/UE is involved.

The regulator requests an information about established communication in which actor users/UEs are involved.

### 4.5.2 Request From a Business Actor

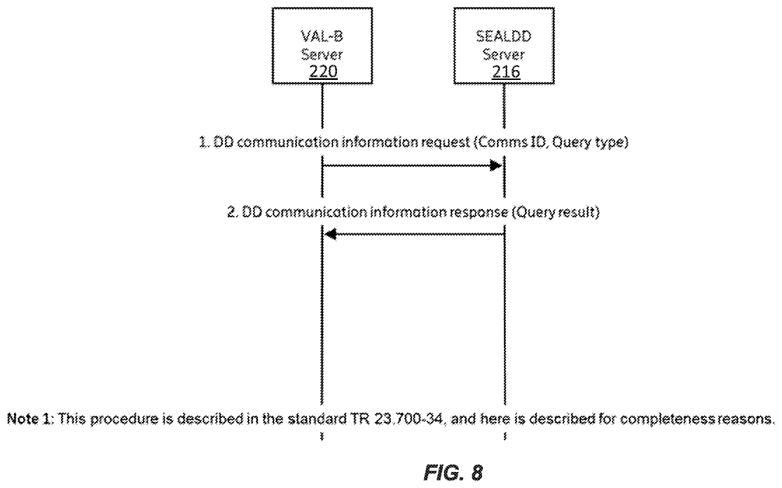

FIG. 8 illustrates the procedure used for querying the DD communication information triggered by a business actor.

Pre-conditions:
The business actor wants to monitor the communication performance, e.g., latency or reliability, and if it complies to agreed Service Level Agreements (SLAs).

The steps of the procedure of FIG. 8 are as follows:
Step 1:: The VAL-B server 220 sends the communication information request to the SEALDD server 216. The VAL-B server 220 can request the specific communication information through the query type such as data the communication latency performance. Communication ID that is specified in the request has been received from the SEALDD server 216 during the communication establishment beforehand.
Note: The communication information request can be sent by VAL-A server 210 as well.
Step 2:: The SEALDD server 216 provides requested communication information with the communication information response message.

### 4.5.3 Request From the Regulator

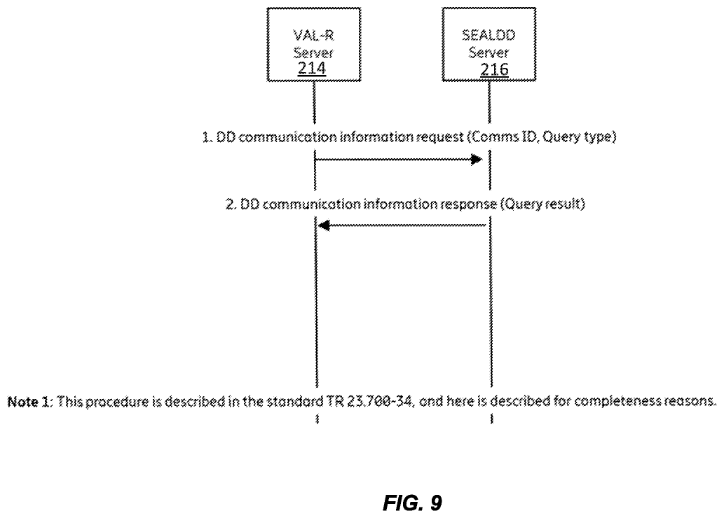

FIG. 9 illustrates the procedure used for querying the DD communication information triggered by the regulator.

Pre-conditions:
The regulator wants to monitor the communication performance, e.g., latency or reliability, and if it complies to agreed SLAs.

The steps of the procedure of FIG. 9 are as follows:
Step 1:: The VAL-R server 214 sends the communication information query request to the SEALDD server 216. The VAL-R server 214 can request the specific communication information through the query type such as data the communication latency performance. Communication ID that is specified in the request has been received from the SEALDD server 216 during the communication establishment beforehand.
Step 2:: The SEALDD server 216 provides requested communication information with the communication information response message.

### 4.6 Data Delivery (dd) Policy Update

### 4.6.1 General

The regulator updates the policy and informs business actors about the policy update.

Pre-conditions:
The policy update has been agreed between the regulator and actors offline or through the communication between VAL servers. This is out of scope of this study.

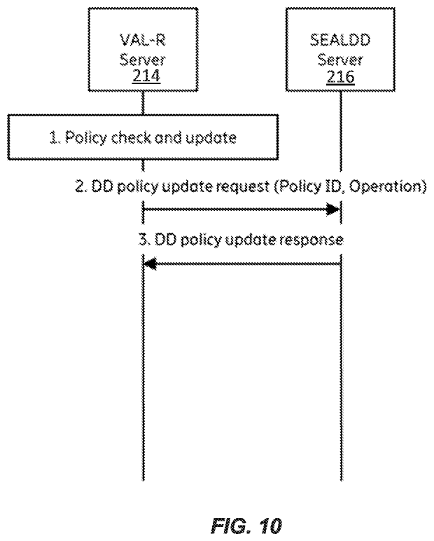

The steps of the DD policy update procedure of FIG. 10 are as follows:
Step 1:: The VAL-R server 214 sends DD policy update request to the SEALDD server 216. The policy update request conveys policy information (e.g., data delivery duration and time, QoS, sender and receiver of the data, etc.), and the operation that will be performed (the policy information will be added, deleted or changed).
Step 2:: Upon receiving the request, the SEALDD server 216 authorizes the request and create a policy. Then the SEALDD server 216 responds to the VAL-R server 214.
Note: Policy ID can be created either by SEALDD server 216 or VAL server 214 in regulator.
After step 2, the VAL-R server 214 may notify the VAL-A client side administrator and VAL-B server side administrator; however, such communication is out of scope of the present disclosure.

### 4.7 Data Delivery (dd) Communication Update

The regulator updates the live communication in some cases, e.g., QoS adjustment.

Pre-conditions:
The SEALDD server has received and stored the policy update beforehand during the policy update procedure.

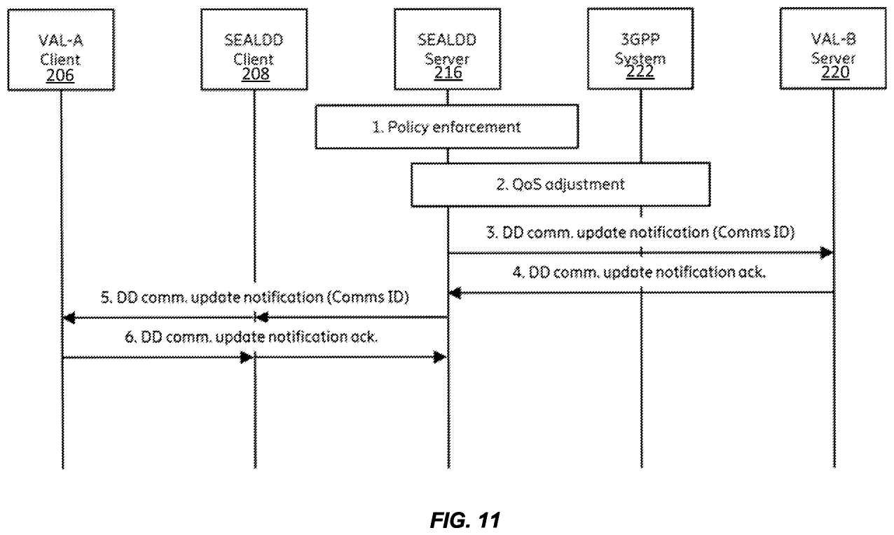

The steps of the DD communication update procedure of FIG. 11 are as follows:
Step 1:: The SEALDD server 216 enforces the communication establishment based on the updated policy that the SEALDD server 216 has received and stored beforehand during the policy update procedure. During the policy update procedure, the SEALDD server 216 has received the policy ID. The SEALDD server 216 finds corresponding communication ID.
Step 2:: The SEALDD server 216 and 3GPP system 222 apply QoS for the data transmission (e.g., by utilizing NEF/PCF service for QoS adjustment). This is an existing 3GPP system function. QoS adjustment is an example of live communication.
Steps 3-4:. The SEALDD server 216 sends DD connection establishment notification to the VAL-B server 220 with VAL service ID, the IP address, and port. The notification is acknowledged by the VAL-B server 220.
Steps 5-6:. The SEALDD server 216 sends DD connection establishment notification to the SEALDD client 208 with VAL service ID, the IP address, and port. The notification is acknowledged by the SEALDD client 208. The SEALDD client 208 further notifies the VAL-A client 206 about the DD connection update.

### 4.8 Data Delivery (dd) Policy Deletion

### 4.8.1 General

The regulator requests the policy deletion and informs actors about the policy deletion.

Pre-conditions:
The policy deletion has been agreed between the regulator and actors. The policy deletion agreement can be achieved offline or through communication between VAL servers. This is out of scope of this document.

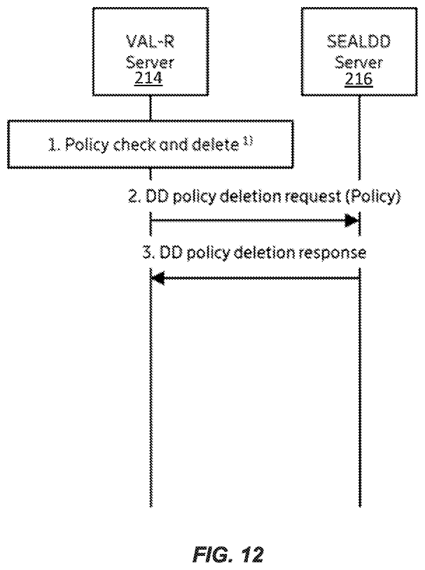

FIG. 12 illustrates the procedure for deleting the DD policy. The steps of the procedure of FIG. 12 are as follows:
Step 1:: The VAL-R server 214 sends DD policy deletion request to the SEALDD server 216. The request includes policy ID to be deleted.
Step 2:: Upon receiving the request, the SEALDD server 216 authorizes the request and removes the policy indicated by the policy ID. Then the SEALDD server 216 responds to the VAL-R server 214.
After step 2, the VAL-R server 214 may notify the VAL-A client side administrator and VAL-B server side administrator. Such communication is out of scope of the present disclosure.
The SEALDD server 216 will enforce the communication deletion as described in the DD communication deletion procedure.

### 4.9 Data Delivery (DD) Communication Deletion

### 4.9.1 General

The regulator requests the DD communication deletion and informs actors about the DD communication deletion.

The regulator or an actor requests communication deletion in an emergency situation.

### 4.9.2 Standard Request

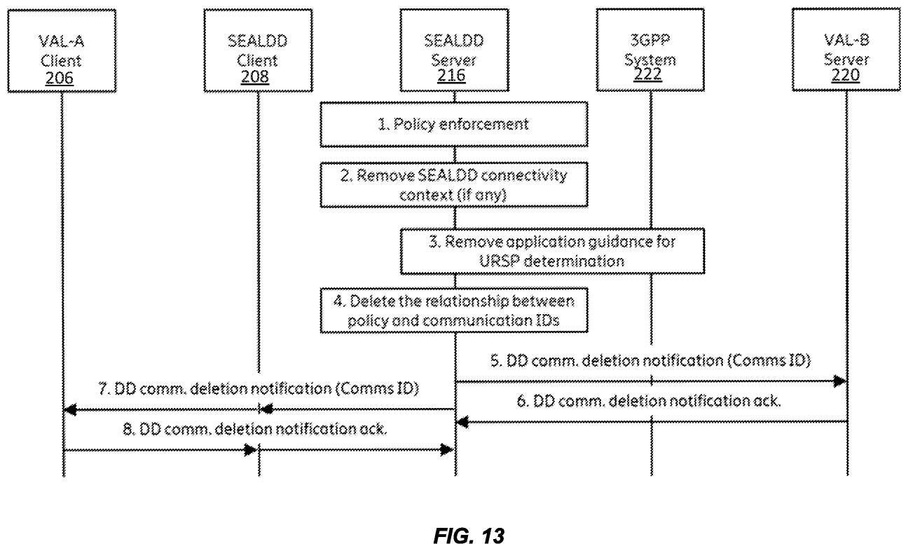

FIG. 13 illustrates the standard procedure used for deleting the DD communication.

### Pre-conditions:

One of the following conditions has been fulfilled: (i) SEALDD server 216 has received the policy deletion request, (ii) the data delivery stop time is reached, or (iii) UE is leaving the area of interest (if spatial condition for UE is provided in the policy).

The steps of the procedure of FIG. 13 are as follows:
Step 1. SEALDD server 216 triggers the communication deletion. SEALDD server 216 relates the received policy ID with the communication ID.
Step 2. If the SEALDD connection was established, the SEALDD server 216 removes the connection (i.e., deletes the DD connection context).
Step 3. If a special routing requirement for SEALDD user plane traffic was provided to 3GPP CN, the SEALDD server 216 interacts with 3GPP CN to remove service specific parameters with NEF as described in 3GPP TS 23.502, clause 4.15.6.7.
Step 4. The SEALDD server 216 deletes the relationship between the policy and the communication IDs.
Steps 5-6. The SEALDD server 216 notifies DD connection deletion to the VAL-B server 220. The notification is acknowledged by the VAL-B server 220.
Steps 7-8. The SEALDD server 216 notifies DD connection deletion to the SEALDD client 208. The notification is acknowledged by the SEALDD client 208. The SEALDD client 208 further notifies the VAL-A client 206 about the DD connection being removed.

### 4.9.3 Emergency Request

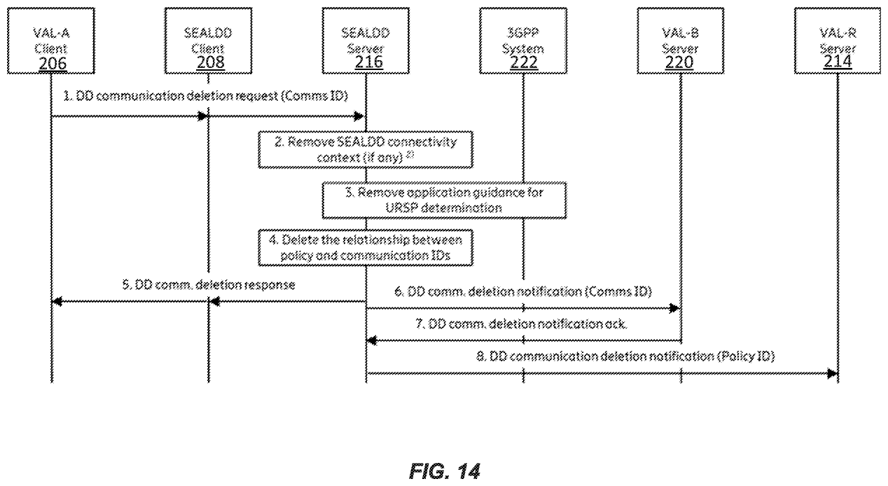

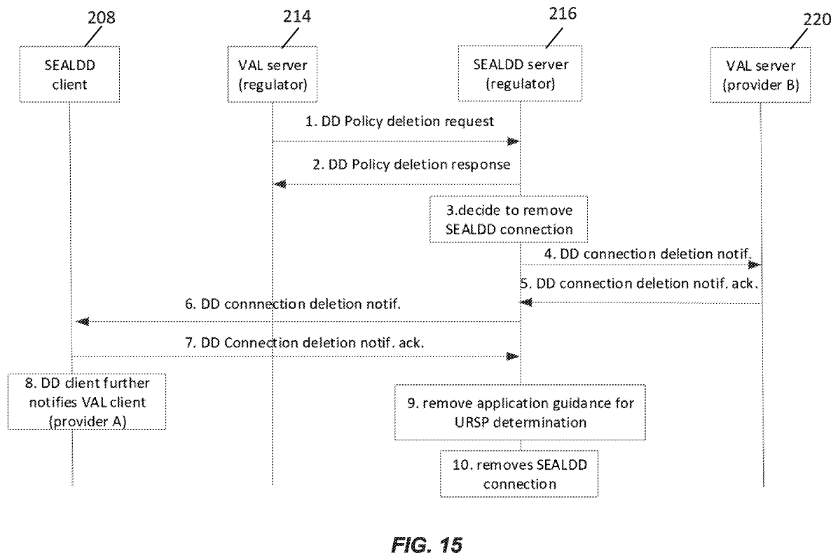

FIG. 14 describes the emergency deletion procedure in the case where the business actor or the regulator has identified that the data delivery has to be urgently stopped. FIG. 15 depicts standard policy deletion procedure.

FIG. 14 illustrates the procedure used for deleting the DD communication in emergency situations.

Pre-conditions:
The business actor or the regulator has identified that the data delivery has to be urgently stopped. In the diagram, the business actor A has identified the need to stop the data delivery by the device.

The steps of the procedure of FIG. 14 are as follows:
Step 1. The VAL-A client 206 requests the communication deletion. The VAL-A client 206 sends the deletion request to the SEALDD client 208 and further to the SEALDD server 216.
Step 2. If the SEALDD connection was established, the SEALDD server 216 removes the connection (i.e., deletes the DD connection context).
Step 3. If a special routing requirement for SEALDD user plane traffic was provided to 3GPP CN, the SEALDD server 216 interacts with 3GPP CN to remove service specific parameters with NEF as described in 3GPP TS 23.502, clause 4.15.6.7.
Step 4. The SEALDD server 216 deletes the relationship between the policy and the communication IDs.
Step 5. The SEALDD server 216 sends the communication deletion response to the VAL-A client 206 via the SEALDD client 208.
Steps 6-7. The SEALDD server 216 notifies DD connection deletion to the VAL-B server 220. The notification is acknowledged by the VAL-B server 220.
Step 8. The SEALDD server 216 provides the policy ID to VAL-R server 214.
Note: VAL-R server 214 will enforce the police deletion afterwards.

FIG. 15 illustrates the standard procedure used for deleting the DD communication in accordance with another embodiment.

Pre-conditions:
The VAL server 220 (provider B) and SEALDD client 208 have subscribed to receive notifications from SEALDD server 216 (regulator).

The steps of the procedure of FIG. 15 are as follows:
Step 1. The VAL server 214 (regulator) sends DD policy deletion request to the SEALDD server 216 (regulator). The request includes policy ID to be deleted.
Step 2. Upon receiving the request, the SEALDD server 216 (regulator) authorizes the request and removes the policy indicated by the policy ID. Then the SEALDD server 216 (regulator) responds to the VAL server 214 (regulator).
Step 3. If the SEALDD connection was established, the SEALDD server 216 decides to remove the connection.
Steps 4-5. The SEALDD server 216 (regulator) notifies DD connection deletion to the VAL server 220 (provider B). The notification is acknowledged by the VAL server 220 (provider B). The application traffic is stopped on both sides.
Steps 6-7. The SEALDD server 216 (regulator) notifies DD connection deletion to the SEALDD client 208. The notification is acknowledged by the SEALDD client 208. The application traffic is stopped on both sides.
NOTE: Step 4 and step 6 can be done in parallel.
Step 8. The SEALDD client 208 further notifies the VAL client 206 (provider A) about the DD connection being removed. The application traffic is stopped on both sides.
Step 9. If a special routing requirement for SEALDD user plane traffic was provided to 3GPP CN, the SEALDD server 216 (regulator) interacts with 3GPP CN to remove service specific parameters with NEF as described in 3GPP TS 23.502, clause 4.15.6.7.
Step 10. The SEALDD server 216 removes the DD connection (i.e., deletes the DD connection context).

### Data Delivery Policy Enforcement

Besides the DD connection establishment triggered by DD policy as described in for example FIG. 4 or 5, during data delivery, the SEALDD server 216 (regulator) also enforces the following policies:
Remove the SEALDD connection when the data delivery stop time is reached or UE is leaving the area of interest (if spatial condition for UE is provided in the policy). The procedure is the same as step 3 to 10 of FIG. 15.
Notify data delivery status of application traffic if a failure detection request is provided in the DD policy; and/or
Apply QOS for the data transmission (e.g., by utilizing NEF/PCF/NRM service for QoS adjustment).

### 6 Further Details

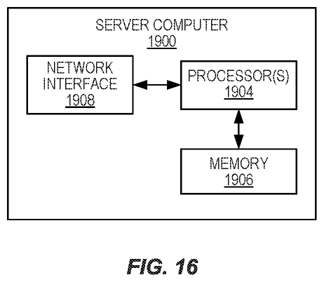

FIG. 16 is a schematic block diagram of a server computer 1900 according to some embodiments of the present disclosure. Optional features are represented by dashed boxes. The server computer 1900 may, for example, implement the functionality of a VAL server or a SEALDD server in accordance with any of the embodiments described herein. As illustrated, the server computer 1900 includes one or more processors 1904 (e.g., Central Processing Units (CPUs), Application Specific Integrated Circuits (ASICs), Field Programmable Gate Arrays (FPGAs), and/or the like), memory 1906, and a network interface 1908. The one or more processors 1904 are also referred to herein as processing circuitry. The one or more processors 1904 operate to provide one or more functions of a VAL server or SEALDD server, as described herein. In some embodiments, the function(s) of a VAL server or SEALDD server are implemented in software that is stored, e.g., in the memory 1906 and executed by the one or more processors 1904.

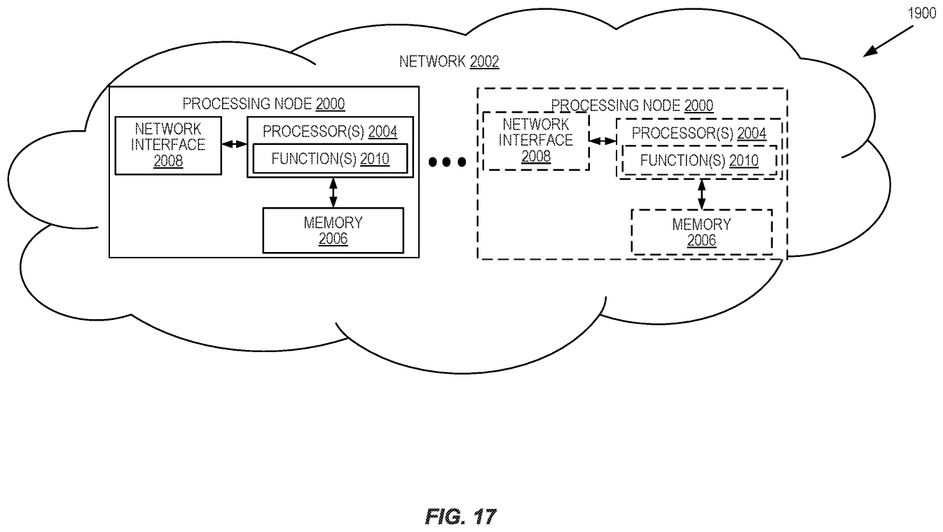

FIG. 17 is a schematic block diagram that illustrates a virtualized embodiment of the server computer 1900 according to some embodiments of the present disclosure. This discussion is equally applicable to other types of network nodes. Further, other types of network nodes may have similar virtualized architectures. Again, optional features are represented by dashed boxes.

As used herein, a “virtualized” server computer is an implementation of the server computer 1900 in which at least a portion of the functionality of the server computer 1900 is implemented as a virtual component(s) (e.g., via a virtual machine(s) executing on a physical processing node(s) in a network(s)). As illustrated, in this example, the server computer 1900 includes one or more processing nodes 2000 coupled to or included as part of a network(s) 2002. Each processing node 2000 includes one or more processors 2004 (e.g., CPUs, ASICs, FPGAs, and/or the like), memory 2006, and a network interface 2008. In this example, functions 2010 of the server computer 1900 described herein (e.g., functions of a VAL server or SEALDD server) are implemented at the one or more processing nodes 2000 or distributed across two or more processing nodes 2000 in any desired manner. In some particular embodiments, some or all of the functions 2010 of the server computer 1900 described herein are implemented as virtual components executed by one or more virtual machines implemented in a virtual environment(s) hosted by the processing node(s) 2000.

In some embodiments, a computer program including instructions which, when executed by at least one processor, causes the at least one processor of a server computer or virtual server computer to carry out the functionality of a VAL server or SEALDD server according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

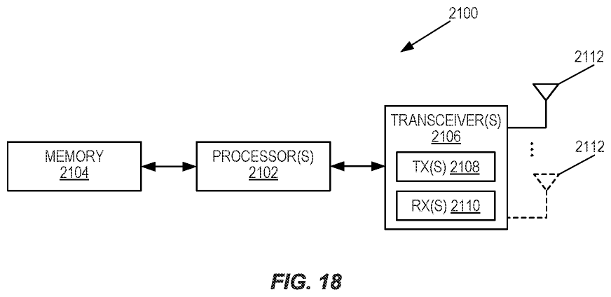

FIG. 18 is a schematic block diagram of a UE 2100 according to some embodiments of the present disclosure. The UE 2100 may be, for example, the VAL-UE described above. As illustrated, the UE 2100 includes one or more processors 2102 (e.g., CPUs, ASICS, FPGAs, and/or the like), memory 2104, and one or more transceivers 2106 each including one or more transmitters 2108 and one or more receivers 2110 coupled to one or more antennas 2112. The transceiver(s) 2106 includes radio-front end circuitry connected to the antenna(s) 2112 that is configured to condition signals communicated between the antenna(s) 2112 and the processor(s) 2102, as will be appreciated by on of ordinary skill in the art. The processors 2102 are also referred to herein as processing circuitry. The transceivers 2106 are also referred to herein as radio circuitry. In some embodiments, the functionality of the UE 2100 (e.g., functionality of the VAL-UE or the like) described above may be fully or partially implemented in software that is, e.g., stored in the memory 2104 and executed by the processor(s) 2102. Note that the UE 2100 may include additional components not illustrated in FIG. 21 such as, e.g., one or more user interface components (e.g., an input/output interface including a display, buttons, a touch screen, a microphone, a speaker(s), and/or the like and/or any other components for allowing input of information into the UE 2100 and/or allowing output of information from the UE 2100), a power supply (e.g., a battery and associated power circuitry), etc.

In some embodiments, a computer program including instructions which, when executed by at least one processor, causes the at least one processor to carry out the functionality of the UE 2100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

The following are just a very few embodiments and are not limiting with respect to the claims.

Embodiment 1: A method performed by a system for Service Enabler Architecture Layer for verticals, SEAL, data delivery via a cellular communications system, the method comprising:
at a Vertical Application Layer, VAL, server of a regulator domain of the system:
   determining a policy, the policy being for data delivery between a client (SEAL DD client) in a first business actor domain of the system and a VAL server in a second business actor domain of the system; and
   providing the policy to a SEAL data delivery server in the regulator domain of the system;
at the SEAL data delivery server of the regulator domain of the system:
   receiving the policy from the VAL server of the regulator domain of the system; and
   enforcing the policy for data delivery between the first business actor domain and the second business actor domain.

Embodiment 2: The method of embodiment 1 wherein enforcing the policy further comprises, at the SEAL data delivery server of the regulator domain:
determining that a data delivery DD communication/connection between the client in the first business actor domain and the VAL server in the second business actor domain should be established,
establishing a DD connection/communication with the client in the first business actor domain via the telecommunication system (e.g., 3GPP system) and with the VAL server in the second business actor domain.

1. A method performed by a system for Service Enabler Architecture Layer for verticals (SEAL) data delivery via a cellular communications system, the method comprising:
at a Vertical Application Layer (VAL) server of a regulator domain of the system:
transmitting, to a SEAL data delivery server in the regulator domain of the system, a request comprising a policy for connection establishment for data delivery from a VAL client in a first business actor domain of the system to a VAL server in a second business actor domain of the system;
at the SEAL data delivery server of the regulator domain of the system:
receiving, from the VAL server of the regulator domain of the system, the request comprising the policy for connection establishment for data delivery from the VAL client in the first business actor domain of the system to the VAL server in the second business actor domain;
authorizing the request; and
storing the policy for enforcement.

2. The method of claim 1, wherein the policy is preconfigured in the regulator domain.

3. The method of claim 1, further comprising, at the SEAL data delivery server in the regulator domain of the system:
determining that the policy for connection establishment for data delivery is to be enforced; and
in accordance with the policy:
sending, via a cellular communications system, a data delivery connection establishment notification to a SEAL data delivery client in the first business actor domain of the system that communicates with the VAL client in the first business actor domain of the system, for establishing a first connection for data delivery;
sending a data delivery connection establishment notification to the VAL server in the second business actor domain, for establishing a second connection for data delivery; and
enabling data delivery between the VAL client via the SEAL data delivery client and the VAL server over the first and the second connections.

4. The method of claim 1, further comprising:
at the VAL server in the regulator domain:
determining that the policy for data delivery is to be updated,
transmitting, to the SEAL data delivery server in the regulator domain of the system, an update request comprising an updated policy for connection establishment for data delivery from the VAL client in the first business actor domain of the system to the VAL server in the second business actor domain of the system;
at the SEAL data delivery server in the regulator domain:
receiving the update request comprising the updated policy;
authorizing the update request; and
storing the updated policy to be enforced.

5. The method of claim 1, further comprising, at the SEAL data delivery server of the regulator domain:
determining to delete the second connection with the VAL server in the second business actor domain and the first connection with the SEAL data delivery client in the first business actor domain;
notifying the VAL server in the second business actor domain that the second connection is to be deleted; and
notifying the SEAL data delivery client that the first connection is to be deleted.

6. A method performed by a Service Enabler Architecture Layer for verticals (SEAL) data delivery server of a regulator domain of a system for providing SEAL data delivery via a cellular communications system, the method comprising:
receiving, from a Vertical Application Layer (VAL) server of the regulator domain of the system, a request comprising a policy for connection establishment for data delivery from a VAL client in a first business actor domain of the system to the VAL server in a second business actor domain of the system;
authorizing the request; and
storing the policy for enforcement.

7. The method of claim 6, wherein the policy is preconfigured in the regulator domain.

8. The method of claim 6, further comprising:
determining that the policy for connection establishment for data delivery is to be enforced; and
in accordance with the policy:
sending, via a cellular communications system, a data delivery connection establishment notification to a SEAL data delivery client in the first business actor domain of the system that communicates with the VAL client in the first business actor domain of the system, for establishing a first connection for data delivery;
sending a data delivery connection establishment notification to the VAL server in the second business actor domain, for establishing a second connection for data delivery; and
enabling data delivery between the VAL client via the SEAL data delivery client and the VAL server over the first and the second connections.

9. The method of claim 6, further comprising:
receiving, from the VAL server in the regulator domain of the system, an update request comprising an updated policy for connection establishment for data delivery from the VAL client in the first business actor domain of the system to the VAL server in the second business actor domain of the system;
authorizing the update request; and
storing the updated policy to be enforced.

10. The method of claim 6, further comprising:
determining to delete the second connection with the VAL server in the second business actor domain and the first connection with the SEAL data delivery client in the first business actor domain;
notifying the VAL server in the second business actor domain that the second connection is to be deleted; and
notifying the SEAL data delivery client that the first connection is to be deleted.

11. A Service Enabler Architecture Layer for verticals (SEAL) data delivery server for a regulator domain of a system for providing SEAL data delivery via a cellular communications system, the SEAL data delivery server adapted to:
receive, from a Vertical Application Layer (VAL) server of the regulator domain of the system, a request comprising a policy for connection establishment for data delivery from a VAL client in a first business actor domain of the system to the VAL server in a second business actor domain of the system;
authorize the request; and
store the policy for enforcement.

12. The SEAL data delivery server of claim 11, wherein the policy is preconfigured in the regulator domain.

13. The SEAL data delivery server of claim 11, wherein the SEAL data delivery server is further adapted to:
determine that the policy for connection establishment for data delivery is to be enforced; and
in accordance with the policy:
send, via a cellular communications system, a data delivery connection establishment notification to a SEAL data delivery client in the first business actor domain of the system that communicates with the VAL client in the first business actor domain of the system, for establishing a first connection for data delivery;
send a data delivery connection establishment notification to the VAL server in the second business actor domain, for establishing a second connection for data delivery;
enable data delivery between the VAL client via the SEAL data delivery client and the VAL server over the first and the second connections.

14. The SEAL data delivery server of claim 11, further adapted to:
receive, from the VAL server in the regulator domain of the system, an update request comprising an updated policy for connection establishment for data delivery from the VAL client in the first business actor domain of the system to the VAL server in the second business actor domain of the system; and
authorize the update request; and
store the updated policy to be enforced.

15. The SEAL data delivery server of claim 11, further adapted to:
determine to delete the second connection with the VAL server in the second business actor domain and the first connection with the SEAL data delivery client in the first business actor domain; and
notify the VAL server in the second business actor domain that the second connection is to be deleted; and
notify the SEAL data delivery client that the first connection is to be deleted.

16. A server computer for implementing a Service Enabler Architecture Layer for verticals (SEAL) data delivery server for a regulator domain of a system for providing SEAL data delivery via a cellular communications system, the server computer comprising:
a network interface; and
processing circuitry associated with the network interface, the processing circuitry configured to cause the server computer to, in order to operate as the SEAL data delivery server:
receive, from a Vertical Application Layer (VAL) server of the regulator domain of the system, a request comprising a policy for connection establishment for data delivery from a VAL client in a first business actor domain of the system to the VAL server in a second business actor domain of the system;
authorize the request; and
store the policy for enforcement.

17. The server computer of claim 16, wherein the policy is preconfigured in the regulator domain.

18. The server computer of claim 16, wherein the processing circuitry is further configured to cause the server computer to, in order to operate as the SEAL data delivery server:
determine that the policy for connection establishment for data delivery is to be enforced; and
in accordance with the policy:
send, via a cellular communications system, a data delivery connection establishment notification to a SEAL data delivery client in the first business actor domain of the system that communicates with the VAL client in the first business actor domain of the system, for establishing a first connection for data delivery;
send a data delivery connection establishment notification to the VAL server in the second business actor domain, for establishing a second connection for data delivery;
enable data delivery between the VAL client via the SEAL data delivery client and the VAL server over the first and the second connections.

19. The server computer of claim 16, wherein the processing circuitry is further configured to cause the server computer to, in order to operate as the SEAL data delivery server:
receive, from the VAL server in the regulator domain of the system, an update request comprising an updated policy for connection establishment for data delivery from the VAL client in the first business actor domain of the system to the VAL server in the second business actor domain of the system; and
authorize the update request; and
store the updated policy to be enforced.

20. The server computer of claim 16, wherein the processing circuitry is further configured to cause the server computer to, in order to operate as the SEAL data delivery server:
determine to delete the second connection with the VAL server in the second business actor domain and the first connection with the SEAL data delivery client in the first business actor domain; and
notify the VAL server in the second business actor domain that the second connection is to be deleted; and
notify the SEAL data delivery client that the first connection is to be deleted.

21. (canceled)

22. (canceled)

23. A non-transitory computer-readable medium comprising instructions executable by processing circuitry of a server computer, whereby the server computer is, in order to operate as a Service Enabler Architecture Layer for verticals (SEAL); data delivery server for a regulator domain of a system for providing SEAL data delivery via a cellular communications system, operatable to:
receive, from a Vertical Application Layer (VAL) server of the regulator domain of the system, a request comprising a policy for connection establishment for data delivery from a VAL client in a first business actor domain of the system to the VAL server in a second business actor domain of the system;
authorize the request; and
store the policy for enforcement.
